(19) United States
(12) Patent Application Publication
(10) Pub. No.: US 2025/0389276 A1
(43) Pub. Date: Dec. 25, 2025

(54) RADIAL PUMP STAGE, SENSOR CLEANING DEVICE AND VEHICLE

(71) Applicant: Schaeffler Technologies AG & Co. KG, Herzogenaurach (DE)

(72) Inventors: Johannes DEICHMANN, Rotenburg (DE); Andreas SCHMICK, Rotenburg (DE)

(21) Appl. No.: 19/243,963

(22) Filed: Jun. 20, 2025

(30) Foreign Application Priority Data
Jun. 21, 2024 (DE) 10 2024 205 815.7

(51) Int. Cl. F04D 29/22; B60S 1/48; B60S 1/56; F04D 1/00; F04D 29/42

(52) U.S. Cl. CPC F04D 29/2222; B60S 1/56; F04D 1/00; F04D 29/242; F04D 29/4293; B60S 1/48; F04D 29/2216; F04D 29/281

(57) ABSTRACT

A radial pump stage having a pump impeller which includes a plurality of guide vanes that extend in the axial direction. A sensor cleaning device having a radial pump stage of this kind, and to a vehicle having a radial pump stage of this kind or a sensor cleaning device of this kind.

### BACKGROUND OF THE INVENTION

### 1. Field of the Invention

The disclosure relates to a radial pump stage, to a sensor cleaning device comprising a radial pump stage of this kind, and to a vehicle comprising a radial pump stage of this kind and/or a sensor cleaning device of this kind.

### 2. Description of Related Art

Document DE 10 2018 217 179 A1 discloses a pump stage for delivering a liquid.

Disadvantages of the devices in the prior art are in particular the flow properties of the pump stage, which result from the design of the pump impeller.

### SUMMARY OF THE INVENTION

One aspect of the present invention is to provide an alternative radial pump stage which is distinguished in particular by its improved flow properties, a sensor cleaning device comprising a radial pump stage of this kind, a vehicle comprising a sensor cleaning device of this kind and/or a radial pump stage of this kind.

An exemplary embodiment of the invention relates to a radial pump stage, having a pump stage housing and a semi-open pump impeller arranged therein, the pump stage housing having an axially arranged suction inlet, which leads into the pump stage housing, and a radially arranged pressure outlet, which leads out of the pump stage housing,

the pump impeller comprising a plurality of guide vanes, and at least one of the plurality of guide vanes or all of the plurality of guide vanes extending in the axial direction.

This creates a radial pump stage which is distinguished in particular by its improved flow properties.

A semi-open pump impeller is preferably understood to mean a pump impeller that comprises a wall extending in a plane perpendicular to the rotation axis of the pump impeller. This wall is preferably formed without axial openings or axial penetrating elements, in particular except for a shaft receptacle or shaft hub. It is also preferred if the wall is circular in the plane perpendicular to the rotation axis of the pump impeller.

The semi-open pump impeller, preferably with its open side, faces the suction inlet. The guide vanes are preferably located on a side of the pump impeller that faces the suction inlet.

It is preferred if there are five, in particular only five, guide vanes. Regardless of the number of guide vanes, it is preferred if the distance between the guide vanes decreases in the direction of the suction inlet. In addition or independently of this, it is preferred if the distance between the guide vanes increases in the direction of the pressure outlet.

Furthermore, it is preferred if the axial height of the pump impeller corresponds to 2 to 5.5 times the height of the guide vanes or webs. For this purpose, it is preferred if the average height of the guide vanes or webs, the minimum height of the guide vanes or webs or the maximum height of the guide vanes or webs, is used, that is to say in particular as a basis for the height of the guide vanes. It is particularly preferred if the value corresponds to 2.5 to 5 times or three to four times, instead of 2 to 5.5 times. It is also preferred if the axial height of the pump impeller is measured in the direction of a or the rotation axis of the pump impeller or perpendicularly to a surface at the base of the guide vanes or webs.

In addition, it is preferred if a radial gap running in the circumferential direction of the pump impeller, limited by the pump impeller and the pump stage housing, increases, in particular steadily, in a plane perpendicular to the rotation axis of the pump impeller in the direction of the pressure outlet. This refers in particular to the size of the gap, that is to say the distance of the pump impeller from the inner wall of the pump stage housing in said plane. As an alternative or in addition, portions with a constant radial gap are conceivable.

Furthermore, it is preferred if the pressure outlet, in particular in the flow direction of a liquid to be conveyed through the radial pump stage, is rectangular. In other words, the pressure outlet has a rectangular cross section or flow cross section. The rectangularity, in particular the rectangular cross section or flow cross section, is preferably formed in such a way that the four corners are rounded. The term corner is to be understood to mean, in particular, a transition from a long side to a short side of a rectangle, or vice versa.

In addition, it is preferred if the rectangular pressure outlet, in particular with the four rounded corners, opens into a flow channel, the cross section or flow cross section of which transitions steadily from the rectangular cross section or flow cross section of the pressure outlet into an oval or circular flow cross section over the extension length of the flow channel. The oval or circular flow cross section preferably forms a pump stage outlet. It is particularly preferred if liquid lines can be connected or a liquid line is connected to this pump stage outlet. A liquid line of this kind is preferably connected in a liquid-transmitting manner to a consumer to be supplied with the liquid. The liquid is the liquid that can be conveyed through the radial pump stage. The consumers are preferably nozzles which are directed to, in particular optical or acoustic, sensors.

It is expedient if at least one of the plurality of guide vanes or all of the plurality of guide vanes extend as far as into the suction inlet. As an alternative or in addition, it is conceivable that one of the plurality of guide vanes or all of the plurality of guide vanes extend as far as into a region of the pump stage housing that directly adjoins the suction inlet. The region is preferably an, in particular conical, suction channel.

A preferred exemplary aspect is characterized in that the guide vanes, as seen from the suction inlet, extend in a straight line from a shaft hub of the pump impeller to an outer circumference of the pump impeller. In other words, a projection of the webs onto a plane perpendicular to the rotation axis of the pump impeller runs in a straight line from the shaft hub radially to the outside. As an alternative or in addition, it is preferred that at least one or all of the guide vanes has/have a curvature in a plane in which the rotation axis of the pump impeller and/or one of the guide vanes runs.

Furthermore, it is preferred if the guide vanes, as seen from the suction channel, are uniformly spaced apart in the circumferential direction. The meaning of the spacing is preferably an angular spacing which refers to the rotation axis of the pump impeller.

A further preferred exemplary embodiment is characterized in that the guide vanes are in the form of webs which extend along an inner wall of the pump stage housing, and in that the inner wall is located opposite that side of the pump impeller which faces the suction inlet. The webs preferably have a constant or variable spacing from the inner wall of the pump stage housing. In the case that the webs have a variable spacing from the inner wall of the pump stage housing, it is preferred if the spacing of the webs from the inner wall of the pump stage housing is designed to increase or decrease in the direction of the outer circumference of the pump impeller. Manufacturing tolerances can be addressed in this way. The flow properties of the radial pump stage can also be further improved.

A further preferred exemplary embodiment is characterized in that surfaces are located between the webs or between the bases of the guide vanes and in that the webs extend perpendicularly to the surfaces. These surfaces are preferably designed to be free of penetrating elements and/or form the wall of the pump impeller. The bases of the guide vanes are, in particular, the transitions or connections of the guide vanes to the surfaces.

It is also preferred if the guide vanes have molding draft angles. It is particularly preferred if the thickness of the guide vanes decreases due to the drafts in the direction of the suction inlet or the suction channel. Firstly, this enables manufacture, for example by means of a casting process or plastic injection molding, and secondly the largest possible cross section of the suction inlet is ensured at the same time, as a result of which the highest possible degree of efficiency is ensured.

Furthermore, the pump impeller is preferably drive-connected to a shaft by a shaft hub. The shaft is preferably inserted into the pump stage housing through the suction inlet. It is preferred if the shaft extends into the hub and in particular thus into the pump impeller. The surfaces of the pump impeller preferably form a constant extension of the outside diameter of the shaft portion, which directly axially adjoins the pump impeller. It is also preferred that an annular gap is formed between the shaft portion and the pump stage housing. The annular gap is preferably conical in the extension direction of the shaft.

In addition, it is conceivable that the pump impeller has a cylindrical portion which axially, in particular directly, adjoins the guide vanes and forms a continuous transition to the outside diameter of the shaft. It is preferred if the annular gap is formed between the cylindrical portion and the pump stage housing. The cylindrical portion preferably transitions continuously into the surfaces of the pump impeller. In addition, the portion is preferably formed in one-piece with the pump impeller.

Furthermore, it is preferred if the number of guide vanes corresponds to an odd number of guide vanes, preferably five guide vanes. This prevents vibrations of an, in particular electromotive, drive from being transmitted to the pump stage or to the pump impeller, or vice versa, and thus amplified. As an alternative, the number of guide vanes may correspond to a number that is divisible by five.

In addition, it is preferred if the pump impeller has recesses that ensure a material thickness or material accumulation that is as uniform as possible. This prevents air pockets and material defects during casting processes or plastic injection molding processes for producing the pump impeller.

It is also preferred if the pump impeller, on the side of the pump impeller facing away from the suction inlet, has a spacing from the pump stage housing that is only half as large as on the side of the pump impeller that faces the suction inlet. As an alternative, the spacing on the side that faces away may be 0.3 to 0.5 mm smaller than on the side of the pump impeller that faces the suction inlet. In particular, the respective spacing is always measured between the respective pump impeller side and the pump stage housing wall located opposite the pump impeller side.

A further preferred exemplary embodiment is characterized in that the webs have a height measured perpendicularly to the surfaces, and in that the height is designed to increase or be constant in the direction of the outer circumference of the pump impeller. This can also advantageously influence the flow properties of the radial pump stage.

As an alternative or in addition to this, it is advantageous if the webs have a constant material thickness, that is to say thickness or width, measured perpendicularly to their radial extension direction, over their entire extension length.

It is also preferred if the webs have a constant material thickness over their entire height. As an alternative to this, it is preferred if the webs have an increasing wall thickness as the spacing from the suction inlet increases. The latter simplifies manufacture and demolding after a plastic injection molding process. In other words, the webs have demolding draft angles.

All of these measures, which affect the web height and/or material thickness of the webs, simplify manufacture of the pump impeller. Instead of these measures or one of these measures applying to all of the webs, it is also conceivable to form a structural design or measure of this kind only for one web or at least one web.

The pump impeller is preferably produced by way of plastic injection molding. The pump impeller is particularly preferably formed without undercuts in the direction of the extent of the rotation axis of the pump impeller.

A further preferred exemplary aspect is characterized in that the surfaces extend completely along the webs and/or from the suction inlet of the pump stage housing as far as the outer circumference of the pump impeller. This reliably prevents turbulence that could reduce the degree of efficiency of the radial pump stage.

A further preferred exemplary aspect is characterized in that the surfaces have a curvature in their extent from the suction inlet of the pump stage housing to the outer circumference of the pump impeller, and/or in that the webs have a curvature in their extent from the suction inlet of the pump stage housing to the outer circumference of the pump impeller. The curvature is preferably a concave curvature. It is particularly preferred if the curvature has a constant radius of curvature or a variable radius of curvature that either increases or decreases along the extent of the surface. The curvature can be measured in a plane in which the rotation axis of the pump impeller runs.

The curvature is preferably a constant or variable curvature. The curvature may have an elliptical or a polynomial shape here. The curvatures of the surfaces and the webs preferably run parallel to each other. The curvature of the webs is preferably a curvature of the guide vane head of the guide vane in a plane perpendicular to the rotation axis of the pump impeller or the shaft.

The radius of at least one of the curvatures preferably has a value that corresponds to the value of the inside or outside diameter of the hub. The curvature of the surface, at a location which is at a distance from the outside diameter of the pump impeller at least by a distance corresponding to double the guide vane height at the outermost diameter of the guide vanes, preferably transitions into a completely straight-lined, radial surface portion, that is to say a surface portion running perpendicularly to the rotation axis of the pump impeller.

Furthermore, it is preferred if the flow cross section, preferably in the flow direction of a liquid that can be conveyed by the radial pump stage, limited by the guide vanes, the surfaces and the pump housing, steadily increases from the suction inlet arranged axially to the pump impeller in the direction of the outside diameter of the pump impeller. This prevents pressure losses and increases the degree of efficiency. The flow cross section is preferably measured transversely, preferably perpendicularly, to the flow direction of the liquid that can be conveyed by the radial pump stage.

A further preferred exemplary aspect is characterized in that the pump stage housing, in a plane perpendicular to the rotation direction of the impeller, has an integrally connected parting plane or is sealed off by a sealing element. The integral connection is preferably fluid- or liquid-tight. The parting plane preferably divides the pump stage housing into two parts or two regions. In other words, the integrally connected parting plane means that the two parts or two regions of the pump stage housing are connected to each other by an integral connection. The pump stage housing is preferably formed from plastic, which makes it very cost-effective in terms of production. Ultrasonic welding, for example, can be used as a method for establishing the integral connection. It is expedient if the parting plane runs in such a way that the pump impeller can be received into the pump stage housing before the integral connection is established. In the case that no integral connection is provided, the two parts or the two regions are connected to each other, for example, frictionally, preferably by means of a screw connection or a clamping connection. An elastomeric seal, for example, can be used as a sealing element. The integral connection or the sealing element prevents a liquid to be conveyed from unintentionally escaping from the pump stage.

A sensor cleaning device for a vehicle, the sensor cleaning device having a radial pump stage according to one aspect of the invention. This creates a sensor cleaning device comprising a particularly efficient radial pump stage.

A vehicle comprising a sensor device according to one aspect of the invention and/or a radial pump stage according to the invention. This creates a vehicle comprising a particularly efficient sensor cleaning device or a particularly efficient radial pump stage.

### BRIEF DESCRIPTION OF THE DRAWINGS

The invention is explained in detail below using exemplary embodiments with reference to the drawings, in which:

FIG. 1A is a first view of a radial pump stage;

FIG. 1B is a sectional view of the radial pump stage;

FIG. 1C is a further sectional view of the radial pump stage; and FIG. 2 is a vehicle.

### DETAILED DESCRIPTION OF THE PRESENTLY PREFERRED EMBODIMENTS

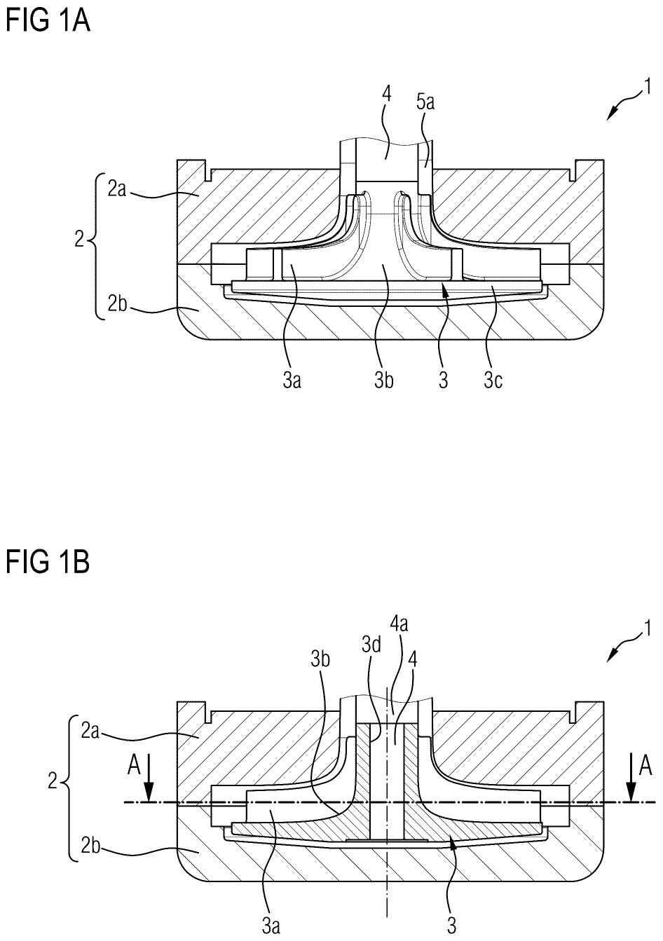

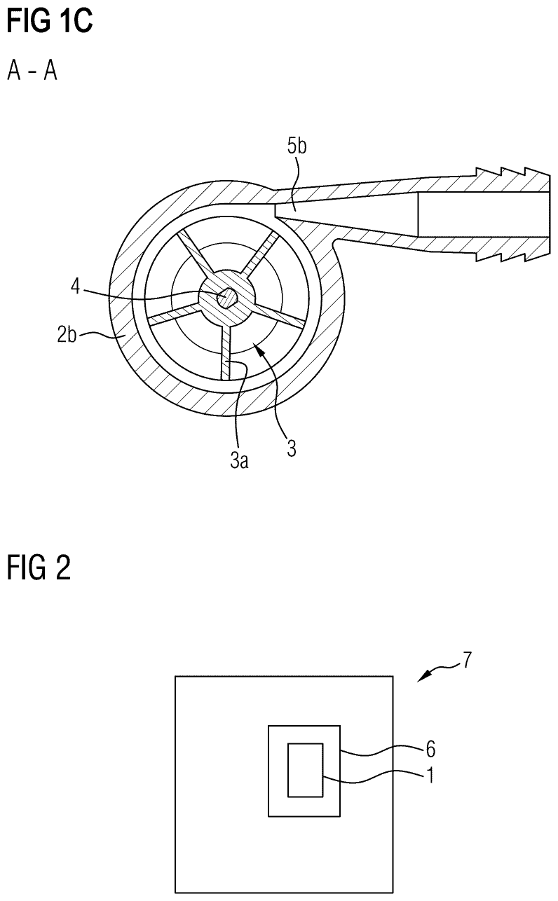

FIG. 1A shows the radial pump stage 1 according to the invention. The radial pump stage 1 comprises a pump stage housing 2 which has a first partial pump stage housing 2a and a second partial pump stage housing 2b. The two partial pump stage housings 2a, 2b consist of plastic and are connected to each other in a fluid-tight manner by ultrasonic welding, so that a seal is not required at their parting plane at which they are joined to each other. The pump stage housing 2 accommodates a pump impeller 3, which is in the form of a semi-open pump impeller 3 with guide vanes 3a. The pump stage housing 2 additionally has a suction inlet 5a and a pressure outlet. The guide vanes 3a extend in the direction of the suction inlet 5a. The pump impeller 3 has a wall 3c on a side of the pump impeller 3 that faces away from the suction inlet 5a. Surfaces 3b of the pump impeller 3 are located between the guide vanes 3a. The pump impeller 3 can be driven by a shaft 4.

FIG. 1B shows a sectional view through the radial pump stage 1 from FIG. 1A. The section of this sectional view runs along the rotation axis 4a of the pump impeller 3. The figure shows the two partial pump stage housings 2a, 2b, which form the pump stage housing 2. The two partial pump stage housings 2a, 2b are separated by the parting plane A-A before the integral connection between the two partial pump stage housings 2a, 2b is established, so that the pump impeller 3 can be received into the pump stage housing 2. The shaft 4 is drive-coupled to the pump impeller 3 by a shaft hub 3d. It can be seen that the height of the guide vanes, measured from the surface, decreases in the direction of the shaft hub 3d and increases in the direction of the outer circumference of the pump impeller 3. Both the surfaces 3b and the guide vanes 3a each have a curvature with a respective radius in the plane shown.

FIG. 1C shows a sectional view which corresponds to the parting plane A-A from FIG. 1B. This figure shows that the second partial pump stage housing 2b has a pressure outlet 5b arranged radially with respect to the pump impeller 3. The shaft 4 can be seen in the middle of the pump impeller 3. It can also be seen that the five guide vanes 3a are uniformly spaced apart, that is to say spaced apart with a uniform angular spacing, in the circumferential direction of the pump impeller 3. In this view, the guide vanes 3a also run in a straight line from the shaft 4 or the shaft hub to the outer circumference of the pump impeller 3.

FIG. 2 shows an autonomously operable vehicle 7 according to one aspect of the invention which has numerous sensors to be cleaned for autonomous operation of the vehicle 7. For this purpose, the vehicle 7 comprises a sensor cleaning device 6. The sensor cleaning device 6 is used regularly to clean the sensors. The sensor cleaning device 6 comprises the radial pump stage 1 according to the invention which can be driven by an electric motor.

The different features of the individual exemplary embodiments can also be combined with each other.

In particular, the exemplary embodiments of FIGS. 1A to 2 are not of a limiting nature and serve to illustrate the concept of the invention.

Thus while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A radial pump stage, comprising:
a pump stage housing having:
an axially arranged suction inlet, which leads into the pump stage housing; and
a radially arranged pressure outlet, which leads out of the pump stage housing; and
a semi-open pump impeller arranged in the pump stage housing, comprising:
a plurality of guide vanes, wherein at least one of the plurality of guide vanes or all of the plurality of guide vanes extend in an axial direction.

2. The radial pump stage as claimed in claim 1, wherein the guide vanes, as seen from the suction inlet, extend in a straight line from a shaft hub of the pump impeller to an outer circumference of the pump impeller.

3. The radial pump stage as claimed in claim 1,
wherein the guide vanes are webs which extend along an inner wall of the pump stage housing, and
wherein the inner wall is located opposite a side of the pump impeller that faces the suction inlet.

4. The radial pump stage as claimed in claim 3, wherein surfaces are located between the webs, and the webs extend perpendicularly to the surfaces.

5. The radial pump stage as claimed in claim 4,
wherein the webs have a web height measured perpendicularly to the surfaces, and
wherein the web height is configured to increase or be constant in a direction of an outer circumference of the pump impeller.

6. The radial pump stage as claimed in claim 4, wherein the surfaces extend completely along the webs and/or from the suction inlet of the pump stage housing as far as an outer circumference of the pump impeller.

7. The radial pump stage as claimed in claim 4, wherein the surfaces have a curvature in their extent from the suction inlet of the pump stage housing to an outer circumference of the pump impeller, and/or the webs have a curvature in their extent from the suction inlet of the pump stage housing to the outer circumference of the pump impeller.

8. The radial pump stage as claimed in claim 1, wherein the pump stage housing, in a plane perpendicular to a rotation direction of the impeller, has an integrally connected parting plane or is sealed off by a sealing element.

9. A sensor cleaning device for a vehicle, comprising:
a radial pump stage comprising:
a pump stage housing having:
an axially arranged suction inlet, which leads into the pump stage housing; and
a radially arranged pressure outlet, which leads out of the pump stage housing; and
a semi-open pump impeller arranged in the pump stage housing, comprising:
a plurality of guide vanes, wherein at least one of the plurality of guide vanes or all of the plurality of guide vanes extend in an axial direction.

10. A vehicle comprising:
a sensor cleaning device comprising:
a radial pump stage comprising:
a pump stage housing having:
an axially arranged suction inlet, which leads into the pump stage housing; and
a radially arranged pressure outlet, which leads out of the pump stage housing; and
a semi-open pump impeller arranged in the pump stage housing, comprising:
a plurality of guide vanes, wherein at least one of the plurality of guide vanes or all of the plurality of guide vanes extend axially; and/or
the radial pump stage comprising:
the pump stage housing having:
the axially arranged suction inlet, which leads into the pump stage housing; and
the radially arranged pressure outlet, which leads out of the pump stage housing; and
the semi-open pump impeller arranged in the pump stage housing, comprising:
the plurality of guide vanes, wherein at least one of the plurality of guide vanes or all of the plurality of guide vanes extend axially.
